(19) United States
(12) Patent Application Publication
(10) Pub. No.: US 2025/0372272 A1
(43) Pub. Date: Dec. 4, 2025

(54) HIGH-POROSITY CERAMIC BURNABLE ABSORBERS

(71) Applicant: Standard Nuclear, Inc., Oak Ridge, TN (US)

(72) Inventors: Raymond Ashton Cutler, Bountiful, UT (US); Kurt A. Terrani, Knoxville, TN (US)

(73) Assignee: Standard Nuclear, Inc., Oak Ridge, TN (US)

(21) Appl. No.: 19/003,484

(22) Filed: Dec. 27, 2024

Related U.S. Application Data
(63) Continuation of application No. PCT/US2023/026668, filed on Jun. 30, 2023.
(60) Provisional application No. 63/357,075, filed on Jun. 30, 2022.

(51) Int. Cl. G21C 7/24; C04B 35/565; C04B 41/45

(52) U.S. Cl. CPC G21C 7/24; C04B 35/565; C04B 41/4531; C04B 2235/3821; C04B 2235/3826; C04B 2235/786

(57) ABSTRACT

A ceramic burnable absorber includes a first phase that includes a boride, a carbide, an oxide, a nitride, a silicide, a mixture, or a solid solution containing naturally occurring boron or enriched boron. The ceramic burnable absorber further includes at least one second phase which bonds to the first phase. Ceramic burnable absorber further includes a porosity that is interconnected and is at least 30 volume percent of the ceramic burnable absorber. In some implementations, the porosity can be open to an outer surface. Ceramic burnable absorber further includes a grain size and a grain contiguity that limit a diffusion distance for helium to less than 10 μm. Ceramic burnable absorber further includes a compressive strength exceeding 30 MPa at approximately 0 to 100 degrees Celsius. Ceramic burnable absorber can be shaped as a pellet, cylinder, polyhedron, prism, spheroid, tube, pipe, ring, truncated portion thereof, or a combination thereof.

### CROSS-REFERENCE TO RELATED APPLICATIONS

This application claims priority to U.S. Provisional Patent Application No. 63/357,075, filed on Jun. 30, 2022, titled “High-Porosity Ceramic Burnable Absorber Pellets,” the entire disclosure of which is incorporated by reference herein.

### BACKGROUND

Burnable absorber pellets are used in nuclear reactors to manage reactivity, allowing those nuclear reactors to operate under controlled conditions over the lifetime of the core. A number of material systems are currently being used to incorporate burnable absorbers and neutron absorbers into nuclear reactors, including Al₂O₃—B₄C, SiO₂—B₂O₃, Gd₂O₃, Er₂O₃, Dy₂O₃, ZrB₂ and fuels coated with such absorbers, (see J. A. Evans, M. D. DeHart, K. D. Weaver, and D. D. Keiser, Jr., “Burnable Absorbers in Nuclear Reactors-A Review,” Nucl. Eng. Design, 391 (2022) 111726). Burnable absorbers are highly dependent on the nuclear reactor design, with efforts made to optimize the performance of the absorber.

The neutron absorption of B-10 isotopes results in the production of Li-7 and He, where accumulation of the latter in the solid may result in swelling, cracking, and delamination problems, making absorbers which produce no helium (He) attractive (see J. P. A. Renier and M. L. Grossbeck, “Development of Improved Burnable Poisons for Commercial Nuclear Power Reactors,” Oak Ridge National Laboratory Report ORNL/TM-2001/238 (October 2001)). It would be advantageous to find a way to use absorbers containing boron, by controlling the extent of He accumulation in the solid to minimize swelling, cracking, and delamination caused by neutron irradiation.

SiC—B₄C composites are used in armor, wear applications, and in nuclear applications (see B. Buyuk and A. B Tugrul, “Gamma and Neutron Attenuation Behaviors of Boron Carbide-Silicon Carbide Composites,” Ann. Nucl. Energy, 71 (2014) 46-51). Using carbon as a sintering aid, it is possible to pressureless sinter B₄C (U.S. Pat. No. 4,195,066) and B₄C—SiC (U.S. Pat. No. 4,524,138) to high sintered densities, as long as the oxygen level is kept low (U.S. Pat. No. 7,919,040), since SiO₂ and B₂O₃ hinder sintering. High-density SiC—B₄C composites have been shown to have lower wear than silicon carbide or boron carbide monolithics (see W. Zhang, “A Novel Ceramic with Low Friction and Wear Towards Tribological Applications: Boron Carbide—Silicon Carbide,” Adv. Coll. Inter. Sci., 301 (2022) 102604).

The B-10 isotope has a large neutron capture cross-section and absorbs neutrons, changing to Li-7 and He-4, as well as emitting some gamma radiation. This absorption causes swelling within the boron carbide, eventually resulting in cracking of the ceramic (see A. L. Pitner and G. E. Russchar, “Irradiation of Boron Carbide Pellets and Powders in Hanford Thermal Reactors,” Westinghouse Report WHAN-FR-24 (December 1970)).

When powders were used, rather than highly sintered boron carbide, helium was able to escape more readily, but swelling still occurred and all pellets and powders were lodged within the Zircaloy holders. The majority of burnable absorber pellets used globally are currently made using high-density alumina-boron carbide absorber cylinders placed within Zircaloy tubes. These pellets require grinding after fabrication. It would be an improvement in the art if burnable absorber pellets could be made in a way that allowed better control over the amount of absorber, lower swelling, and required no post-processing grinding.

### SUMMARY

Advanced gas-cooled nuclear reactors may be designed with a ceramic burnable absorber 100 allowing the nuclear reactor to run for multiple decades without refueling. The ceramic burnable absorber 100 can enable such a long nuclear reactor lifetime by closely controlling the absorber content within the example ceramic burnable absorber 100. The present disclosure allows this to occur by: 1) increasing the volume percent absorber in the solid mixture, thereby allowing a better distribution of the absorber within the ceramic burnable absorber 100; 2) decreasing the diffusion distance 111 for Helium (He) to travel before it escapes through porosity 106 in the ceramic burnable absorber 100; 3) decreasing the stresses arising from differential thermal and swelling due to reduced strain; 4) allowing improved dimensional control so that no grinding is necessary after fabrication of the ceramic burnable absorber 100; and 5) diluting the absorber density and reducing self-shielding effects.

Ceramic burnable absorber 100 can be made from a first phase 103 formed of fine-grained boron carbide surrounded by a second phase 104 formed of silicon carbide in a high-porosity pellet shape (e.g., ceramic burnable absorber pellet 101). Second phase particles 104A-N formed of SiC and first phase particles 103A-N formed of B₄C grains are necked together to form a framework that extends throughout a porous pellet shaped ceramic burnable absorber 100. A porosity 106 of the ceramic burnable absorber 100 is open to surfaces (e.g., outer surface 107) of the pellet and is at least greater than 30 vol. %, preferably greater than 35 vol. %, more preferably equal to or greater than 40 vol. %, or most preferably greater than 45 vol. %. A maximum diffusion distance 111 for He to reach a free surface can be less than 10 μm, preferably less than 5 μm, preferably less than 3 μm, or preferably less than 2 μm. The maximum diffusion distance 111 is the maximum distance to reach a pore 105A-N of the ceramic burnable absorber 100. The linear shrinkage of the ceramic burnable absorber pellet 101 during firing is less than 10%, preferably less than 5%, and most preferably less than 2%. In some examples, once the He reaches a pore 105A-N, the He can pass to the outer surface 107.

The ceramic burnable absorber 100 can be formed into high-porosity ceramic burnable absorber pellets 101 and can have an average room-temperature compressive strength exceeding 30 MPa, more preferably greater than 50 MPa, yet more preferably greater than 75 MPa, and most preferably greater than 100 MPa. The ceramic burnable absorber pellets 101 of the ceramic burnable absorber 100 can be loaded into position within a nuclear reactor without chipping. The increase in compressive strength is indicative of improved necking between first particles 103A-N and second phase particles 104A-N since high compressive strength (>100 MPa) can occur for materials with high porosity 106 as shown by the examples which follow. The first phase particles 103A-N can neck to second phase particles 104A-N or other first phase particles 103A-N. The second phase particles 104A-N can neck to first phase particles 103A-N or other second phase particles 104A-N.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

### BRIEF DESCRIPTION OF THE DRAWINGS

FIG. 1A illustrates a ceramic burnable absorber shaped as a pellet.

FIG. 1B illustrates the ceramic burnable absorber of FIG. 1A and a three-quarter cutaway of a detail area of the ceramic burnable absorber shaped as a pellet.

FIG. 1C illustrates the detail area of the ceramic burnable absorber of FIG. 1B.

FIGS. 2A-B show scanning electron microscope (SEM) images of the detail area of a first example ceramic burnable absorber (Example 1) as depicted in FIGS. 1A-B.

FIGS. 3A-B show SEM images of the detail area of a second example ceramic burnable absorber (Example 2) as depicted in FIGS. 1A-B.

FIG. 4A is a first graph depicting weight loss, diameter shrinkage, and height shrinkage data as a function of the firing temperature for the first example ceramic burnable absorber of FIGS. 2A-B and the second example ceramic burnable absorber of FIGS. 3A-B.

FIG. 4B is a second graph depicting percent theoretical density and open porosity data as a function of the firing temperature for the first example ceramic burnable absorber of FIGS. 2A-B and the second example ceramic burnable absorber of FIGS. 3A-B.

FIG. 5 is a viscosity graph that shows viscosities of third, fourth, and fifth example ceramic burnable absorbers (Examples 3-5).

FIG. 6 show SEM images of a cut surface of the fourth example ceramic burnable absorber (Example 4).

FIG. 7 uses energy dispersive spectroscopy (EDS) to map a portion of the cut surface of the fourth example ceramic burnable absorber (Example 4) heated to 2000° C. for one hour in flowing Ar.

FIG. 8 is a density graph that gives % theoretical density and % open porosity for Examples 8-13 of the ceramic burnable absorber fired at 2100° C. for 1 hour.

FIG. 9 displays SEM images of the cut surface of Examples 8-13 of the ceramic burnable absorber fired at 2100° C. for 1 hour.

FIG. 10 shows secondary images of the fourteenth example of the ceramic burnable absorber (Example 14) fired at 2100° C. for 1 hour.

FIG. 11 shows secondary images of the fifteenth example of the ceramic burnable absorber (Example 15) fired at 2100° C. for 1 hour.

FIG. 12 is a porosity graph 1200 showing that the ceramic burnable absorber can be formed with high porosity over the whole spectrum of porous silicon carbide-boron carbide composites.

### PARTS LISTING

100 Ceramic Burnable Absorber
101 Ceramic Burnable Absorber Pellet
102 Detail Area
103 First Phase
103A-N First Phase Particles 103A-N
104 Second Phase
104A-N Second Phase Particles 104A-N
105A-N Pores
106 Porosity
107 Outer Surface
108 Ceramic CVD Layer
109 Grain Size
110 Grain Contiguity
111 Diffusion Distance
200A—B Secondary Images
201A—B Backscattered Images
202 Pressed Surface
203 Fractured Surface
300A—B Secondary Images
301A—B Backscattered Images
302 Pressed Surface
303 Fractured Surface
400A First Graph
400B Second Graph
500 Viscosity Graph
600A—B Secondary Images
601A—B Backscattered Images
604 Cut Surface
700 Secondary Image 700A
701A—E EDS Maps
800 Density Graph
901A—F Secondary Images
1000A—D Secondary Images
1100A—D Secondary Images
1200 Porosity Graph

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The term “coupled” as used herein refers to any logical or physical connection. Unless described otherwise, coupled elements or devices are not necessarily directly connected to one another and may be separated by intermediate components, elements, etc.

The term “porosity” as used herein refers to a percentage of void space or pore space in a total volume (such as the percentage of void space within the volume of the ceramic burnable absorber 100), the void space or pore space itself within the total volume (such as the void space within the ceramic burnable absorber 100), or both.

Unless otherwise stated, any and all measurements, values, ratings, positions, magnitudes, sizes, angles, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±5% or as much as ±10% from the stated amount. The terms “about,” “approximately,” “generally,” “significantly,” or “substantially” means that the parameter value or the like varies up to ±25% from the stated amount.

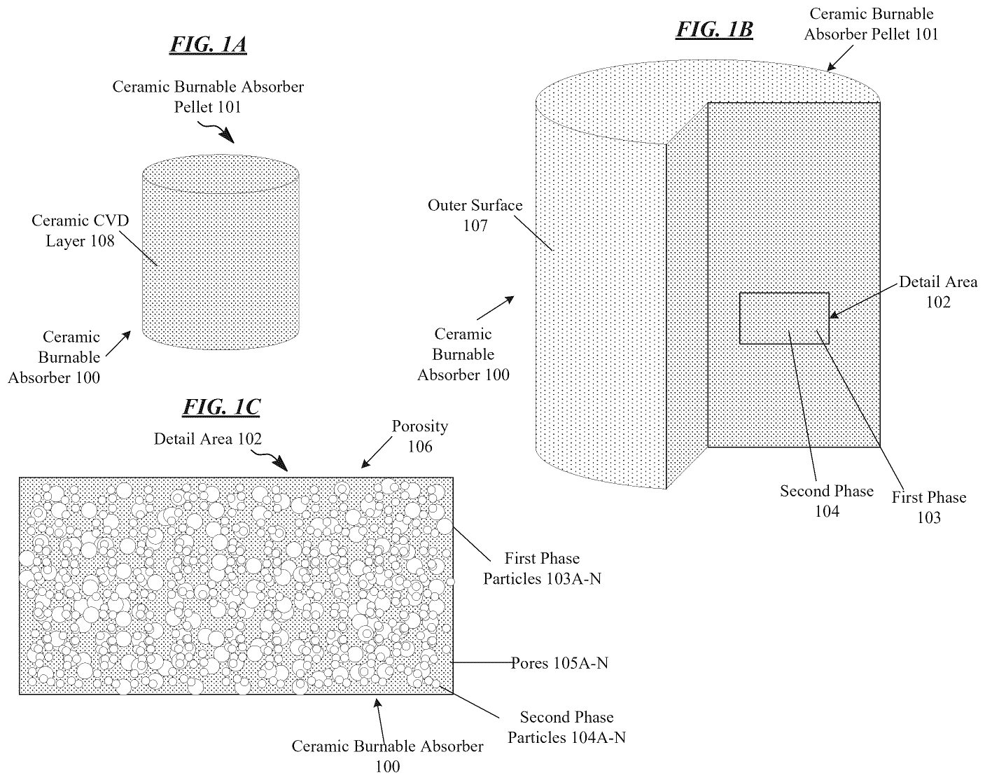

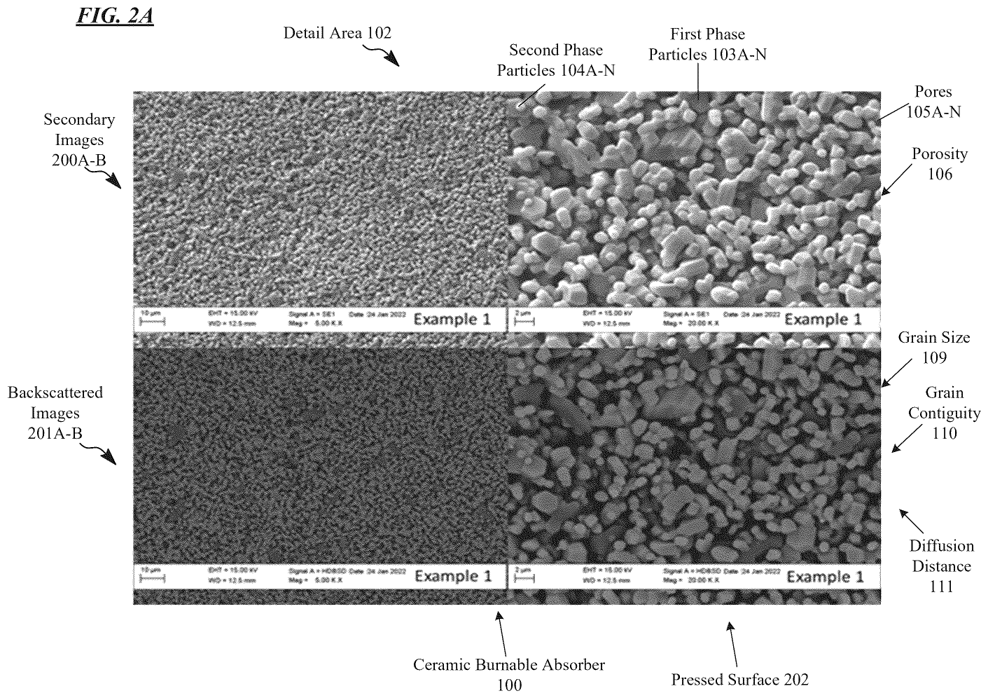

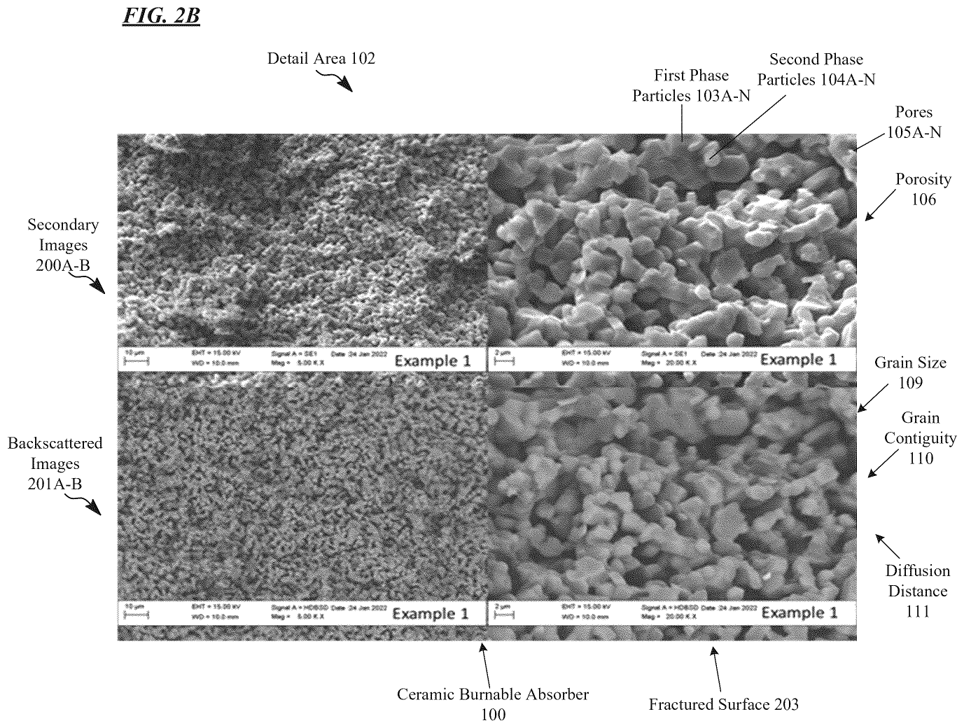

FIG. 1A illustrates a ceramic burnable absorber 100 shaped as a ceramic burnable absorber pellet 101. FIG. 1B illustrates the ceramic burnable absorber 100 of FIG. 1A and a three-quarter cutaway of a detail area 102 of the ceramic burnable absorber 100 shaped as the ceramic burnable absorber pellet 101. FIG. 1C illustrates the detail area 102 of the ceramic burnable absorber 100 of FIG. 1B. Although the ceramic burnable absorber 100 is depicted as pellet-shaped or cylindrical (e.g., ceramic burnable absorber pellet 101), the ceramic burnable absorber 100 can be formed into a variety of shapes.

In addition to being a circular or other round shape in two-dimensional space, the ceramic burnable absorber 100 can be oval, square, rectangular, triangular, or another polygonal shape. For example, the ceramic burnable absorber 10 can be a polyhedron (e.g., cuboid or hexagonal prism) in three-dimensional space. The ceramic burnable absorber 100 can even be shaped as a ring, a tube, or a pipe. Hence, the ceramic burnable absorber 100 can be shaped as a pellet, a cylinder, a polyhedron, a prism, a spheroid, a tube, a pipe, a ring, a truncated portion thereof, or a combination thereof.

Ceramic burnable absorber 100 includes a first phase 103 that includes a boride, a carbide, an oxide, a nitride, a silicide, a mixture, or a solid solution containing naturally occurring boron or enriched boron. The ceramic burnable absorber 100 further includes at least one second phase 104 which bonds to the first phase. The ceramic burnable absorber 100 further includes a porosity 106 that is interconnected and can be open to an outer surface 107 of the ceramic burnable absorber 100 and is at least 30 volume percent (vol. %) of the ceramic burnable absorber 100.

The ceramic burnable absorber 100 further includes a grain size 109 and a grain contiguity 110 that limit a diffusion distance 111 for helium to less than 10 μm. Helium can get trapped in the second phase 104 (e.g., SiC phase) as well as the first phase 103 (e.g., B₄C phase). The grain size 109 and the degree of grain-to-grain contact (the grain contiguity 110) control the distance to the pores 105A-N. Both the first phase particles 103A-N of the first phase 103 (e.g., B₄C) and the second phase particles 104A-N of the second phase 104 (e.g., SiC) have a distribution of grain size(s) 109.

Porosity 106 is the big driver of diffusion distance 111, with higher porosity 106 giving, in general, a shorter diffusion distance 111. The grain size 109 also affects the diffusion distance 111, with larger grain sizes 109 of first phase particles 103A-N and second phase particles 104A-N having larger diffusion distances 111. However, if two or three grains (e.g., first phase particles 103A-N and second phase particles 104A-N) are joined together (are contiguous) then the distance to a pore 105A-N increases. Grain contiguity 110 has the least effect of the three parameters. The diffusion distance 111 for helium in the ceramic burnable absorber 100 can be less than 5 μm or can be less than 3 μm.

The ceramic burnable absorber 100 further includes a compressive strength exceeding 30 MPa at approximately 0 to 100 degrees Celsius. The compressive strength can exceed 50 MPa at a room-temperature of approximately 15 to 25 degrees Celsius. Room-temperature is generally in the range of 15-25 degrees Celsius, but the compressive strength of the ceramic burnable absorber 100 is invariant in the range of 0-100 degrees Celsius. The compressive strength can exceed 100 MPa.

The first phase 103 can include boron carbide and the second phase 104 can include silicon carbide. For example, ceramic burnable absorber 100 can include a porosity 106 of greater than 30 vol. % and all of the porosity 106 can be connected to the surfaces. The porosity 106 can be greater than 35 vol. % or the porosity 106 can be greater than 40 vol. % or the porosity 106 can be greater than 45 vol. %.

The ceramic burnable absorber 100 can be at least 95 wt. % boron carbide with the porosity 106 in excess of 30 volume percent. For example, a control rod of a nuclear reactor including the ceramic burnable absorber 100 can be an example where high boron carbide content may be desired. The ceramic burnable absorber 100 can further comprise a ceramic chemical vapor deposition (CVD) layer 108. For example, the ceramic CVD layer 108 can be greater than 20 μm in thickness. Boron carbide exists over a wide range of stoichiometries, which can make it important to quantify the boron content in the starting powder for the example first phase 103. The B-10 content is approximately 18.4 wt. % of the total boron in the carbide for the example first phase 103. TiB₂ can also be utilized for the first phase 103 and has a much narrower stoichiometry than boron carbide and also does not react with SiC of the example second phase 104, but has a much larger thermal expansion mismatch with SiC than occurs in B₄C—SiC composites. For the second phase 104, silicon carbide has several advantages over alumina as a matrix for boron carbide, including: 1) closer thermal expansion match; 2) higher thermal conductivity; 3) higher use temperature; and 4) compatibility with carbonaceous species in a reducing environment.

In some implementations, where the ceramic burnable absorber 100 further comprises the ceramic CVD layer 108, the ceramic CVD layer 108 can be used to contain tritium (T) and the porosity 106 is not connected to the outer surface 107. Consequently, the He and T are retained in the porosity 106, for example the structure of the pores 105A-N, and build up pressure. Due to the relatively large amount of pore space in the porosity 106, and due to the fact that gas is relatively easily compressed, the ceramic burnable absorber 100 with a ceramic CVD layer 108 can contain T, without additional complexity. Alternatively, without the ceramic CVD layer 108, T escapes and can be gettered in the exiting gas stream. Utilizing a ceramic CVD layer 108 or gettering escaped T are two of the different methods of controlling T in a nuclear reactor. Both methods can also be utilized in the same nuclear reactor in some implementations. Other techniques can also be used.

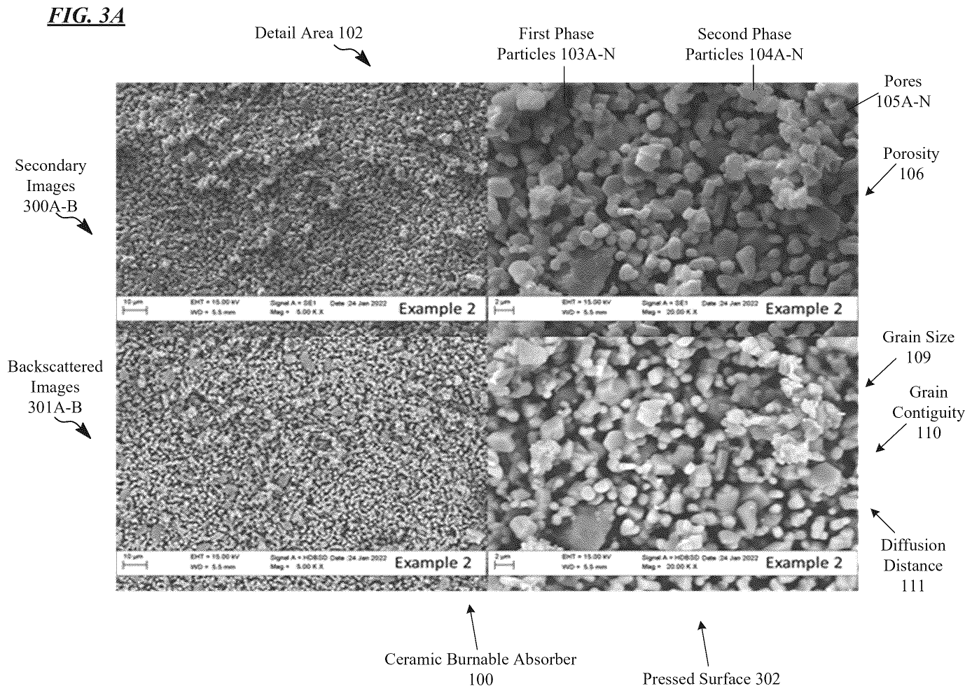

FIGS. 2A-B show scanning electron microscope (SEM) images of the detail area 102 of a first example ceramic burnable absorber 100 (Example 1) as depicted in FIGS. 1A-B. In FIGS. 2A-B the first example ceramic burnable absorber 100 is formed of SiC—B₄C absorbers fired at 1900° C. for 1 hour. Secondary images 200A-B of the ceramic burnable absorber 100 are shown at the top and backscattered images 201A-B of the ceramic burnable absorber 100 are shown on the bottom.

FIG. 2A depicts images of a pressed surface 202 of the first example ceramic burnable absorber 100. The pressed surface is the outer surface 107 of the ceramic burnable absorber 100. The example first phase particles 103A-N are larger B₄C particles and are easier to identify with backscattered images 201A-B due to their lower atomic mass, which makes them appear darker than the smaller SiC grains of the example second phase particles 104A-N.

FIG. 2B depicts images of a fractured surface 203 of the second example ceramic burnable absorber 100. The fractured surface 203 allows a crack to propagate to find its own path. The fracturing of the fractured surface 203 is accomplished by cutting most of the cross-section of the ceramic burnable absorber 100, and then breaking the remaining section. The structure of the ceramic burnable absorber 100 is well-necked together so that the ceramic burnable absorber 100 is robust, yet the distance for He to move out of the grains of the ceramic burnable absorber 100 is short. The grains are the first phase particles 103A-N (e.g., B₄C particles) and second phase particles 104A-N (e.g., SiC particles).

The open microstructure of the ceramic burnable absorber 100 can be advantageous for two reasons: 1) the open microstructure allows for higher B₄C content relative to SiC; and 2) the open microstructure of the pores 105A-N permits He to diffuse easily out of the ceramic burnable absorber pellets 101 due to the short distance to a free surface within the open microstructure of the ceramic burnable absorber 100. The He may reside in the SiC of the second phase 104. The SiC of the second phase 104 is also open and can have even shorter diffusion distance(s) 111 to free surfaces due to the open structure. The free surface is the closest surface to pores 105A-N and can be connected to the outer surface 107 depending on the implementation. For example, if the ceramic burnable absorber 100 comprises a ceramic CVD layer 108, then the free surface may not be open to the outer surface 107. Since the porosity 106 is so high, all of the pores 105A-N can be open (connected to the outer surface 107 in some examples). In other words, the diffusion distance 111 is the distance to one of the pores 105A-N.

The distance to the free surface is typically the grain radius, not the grain diameter. A 20 micron grain would have, at most, at 10 micron diffusion distance 111 by itself. Increasing the grain contiguity 110 (e.g., joining grains together) could increase the diffusion distance 111. There can be lightly-necked grains that still have a maximum diffusion distance 111 of about half the grain size 109. The maximum diffusion distance 111, on average, is the distance from the middle of the grains to the shortest distance to the pores 105A-N. The first phase 103 and the second phase 104 can be somewhat similar in size, as shown in the depicted sintered microstructures of FIGS. 2A-B in the high magnification SEM images. The porosity 106 (e.g., pore space) is very high. At the initial stage of densification, or sintering, the formation of “necks” or “bridges” between first phase particles 103A-N and second phase particles 104A-N occurs as the particles 103A-N, 104A-N bond together. Adjoining particles 103A-N, 104A-N can be bonded together by necking without significant densification. “Lightly necked” means that the bonding between first phase particles 103A-N and second phase particles 104A-N is weak, whereas “well-necked” means the bonding between first phase particles 103A-N and second phase particles 104A-N is strong, although little sintering has occurred. As sintering, or densification, progresses the necks disappear.

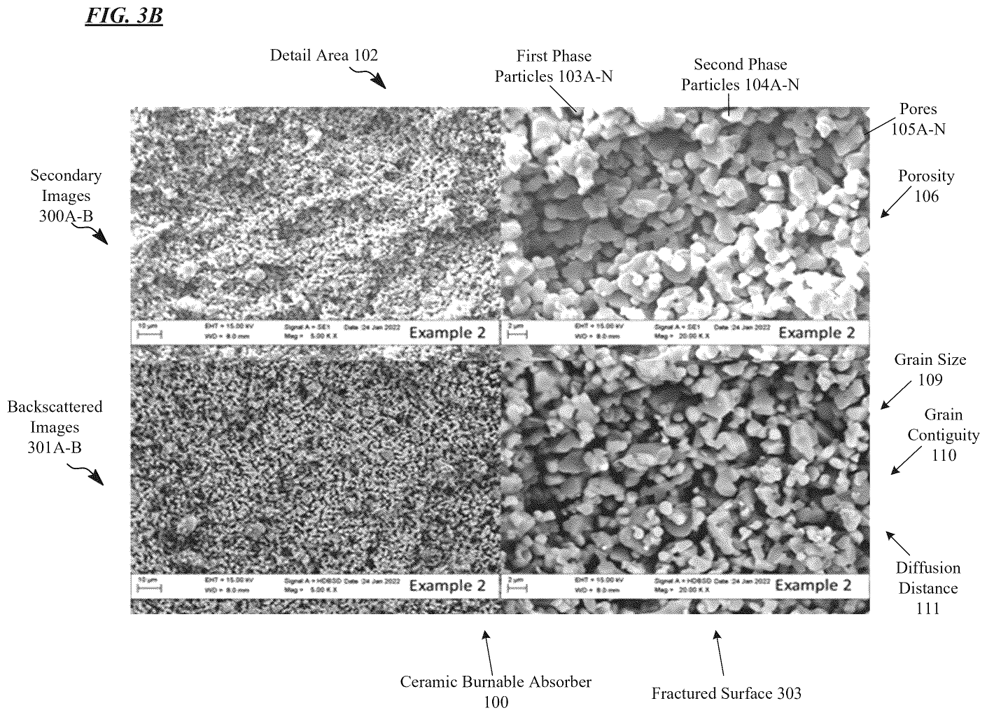

FIGS. 3A-B show SEM images of the detail area 102 of a second example ceramic burnable absorber 100 (Example 2) as depicted in FIGS. 1A-B. In FIGS. 3A-B, the second example ceramic burnable absorber 100 is formed of SiC—B₄C absorbers fired at 1900° C. for 1 hour. Secondary images 300A-B of the ceramic burnable absorber 100 are shown at the top and backscattered images 301A-B are shown at the bottom. FIG. 3A depicts images of a pressed surface 302 and FIG. 3B depicts images of a fractured surface 303 of the second example ceramic burnable absorber 100.

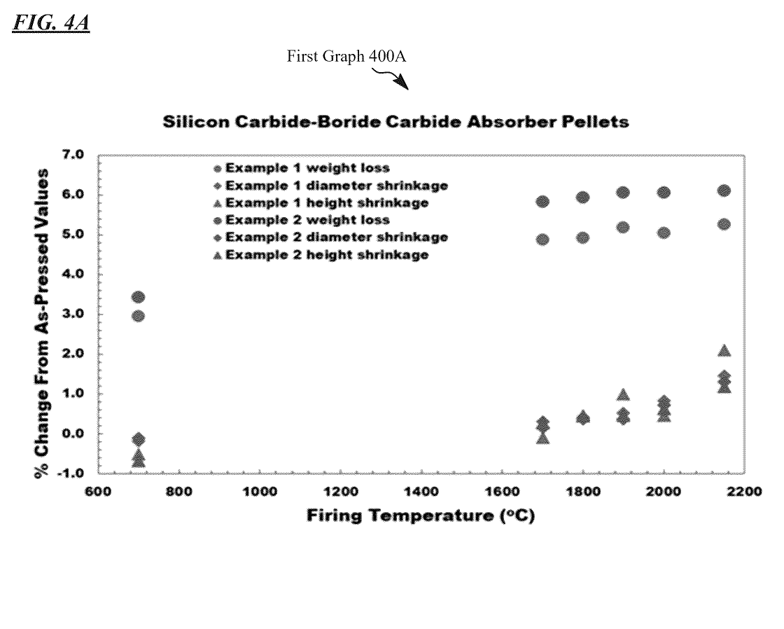

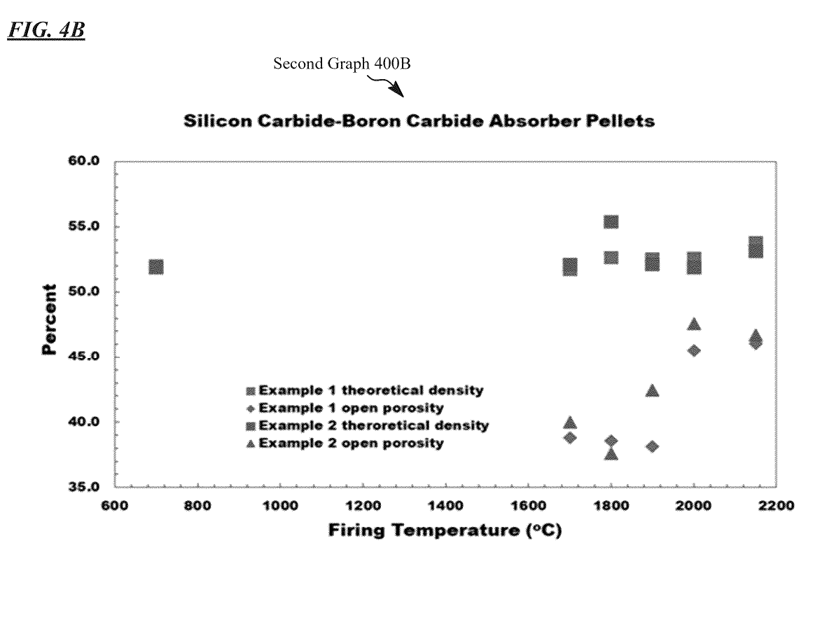

FIG. 4A is a first graph 400A depicting weight loss, diameter shrinkage, and height shrinkage data as a function of the firing temperature for the first example ceramic burnable absorber 100 of FIGS. 2A-B and the second example ceramic burnable absorber 100 of FIGS. 3A-B. FIG. 4B is a second graph 400B depicting percent theoretical density and open porosity data as a function of the firing temperature for the first example ceramic burnable absorber 100 of FIGS. 2A-B and the second example ceramic burnable absorber 100 of FIGS. 3A-B. Comparing FIGS. 2A-B (first example ceramic burnable absorber 100) with FIGS. 3A-B (second example ceramic burnable absorber 100), the second example dispersant was not as effective in keeping the ceramic second phase particles 104A-N dispersed as was the ammonium hydroxide used in the first example ceramic burnable absorber 100. However, the structure of the second example ceramic burnable absorber 100 in FIGS. 3A-B is still open and the porosity 106 is high as shown by the data in the graphs 400A-B of FIGS. 4A-B.

In the first and second examples of the ceramic burnable absorber 100 formed of the ceramic burnable absorber 100 of FIG. 2A through FIG. 4B described herein, alpha SiC powder (45.096 g) with a surface area of 15 m²/g (Washington Mills grade FPG-15) and F1200 grit (3 μm) boron carbide (4.905 g) were added to 30 grams of distilled water. In the first example ceramic burnable absorber 100 (illustrated in FIGS. 2A-B and 4A-B), the pH was adjusted to 9-9.5 using ammonium hydroxide (0.45 g) while in the second example ceramic burnable absorber 100 (illustrated in FIGS. 3A-B and 4A-B), 0.5 grams of a commercially available modified styrene malic acid copolymer (Dispersbyk 199) was added as a dispersant and wetting agent. Polyethylene glycol with a molecular weight of 8000 was used as a binder by adding 1.5 g to each slurry, which was contained in a 60 cc polypropylene bottle containing 150 g of 5 mm diameter tetragonal zirconia mixing media (TOSOH USA). Each sample was mixed on an acoustic mixer (LabRam I, Resodyne Corp., Butte, MT.) at 50 g acceleration for 20 minutes. Each slurry was then poured into a stainless steel pan and frozen using liquid nitrogen, before removing the water using a freeze dryer. The powders were each passed through a 60 U.S. mesh size stainless steel screen and uniaxially die pressed at 100 MPa in a 19 mm diameter steel die. The binder was removed by heating to 700° C. in Ar in 12 hours, holding for one hour, and cooling to room temperature. Ceramic burnable absorber(s) 100 were then heated inside graphite crucibles and in separate crucibles for the two examples at a rate of 500° C./hr to temperatures of 1700° C., 1800° C., 1900° C., 2000° C., or 2150° C. and held for one hour in flowing Ar before cooling to room temperature. Archimedes density and open porosity 106 were measured after water infiltration under vacuum. The fine pore size of the pores 105A-N of the first and second example ceramic burnable absorbers 100 made it difficult to make accurate open porosity 106 measurements unless long times (1-2 days) were allowed for water penetration into the parts.

Ceramic burnable absorber 100 can be designed with a specific B-10 content per unit volume. It is advantageous that the B₄C of the example first phase 103 be well distributed throughout the ceramic matrix for the second phase 104. Increased porosity 106 allows better distribution of the boride. For example, consider a specification that calls for 5×10⁴ atoms of B-10/barn-cm (8.3×10⁻³ g B-10/cc). If a stoichiometric B₄C composition is taken, this results in 5.76×10⁻² g B₄C/cc. A 98% dense B₄C—SiC composite ceramic burnable absorber 100 would be made from a mix of SiC-2.33 vol. % B₄C, whereas a 60% dense composite having the same vol. of boron carbide for the example first phase 103 would be made from a SiC-3.81 vol. % B₄C. Increasing porosity 106 therefore increases the accuracy at which the boron carbide of the first phase 103 can be batched, since there is more boride powder in the batch and the resolution of the scale remains fixed.

Helium diffusion in B₄C has been measured as a function of temperature (see D. Horlait, et al., “Experimental Determination of Intragranular Helium Diffusion Rates in Boron Carbide (B₄C),” J. Nucl. Mater. 527 (2019) 151834). For a ceramic burnable absorber 100 at 600° C., the He diffusion rate is on the order of 4×10⁻⁷ μm²/s, which means the time to diffuse 10 μm of He is about 8 years, 5 μm of He is about 2 years, and 3 μm of He is ≈0.7 years. Having a finer (e.g., smaller) boron carbide grain size 109 and an open structure reduces the He diffusion time. When a coarser (e.g., larger) boron carbide grain size 109 or a less-open structure is used, the trapped He causes microcracks within the grain and the porous structure allows the He a fast diffusion distance 111 (e.g., path). High porosity 106 is therefore advantageous because it decreases swelling, and the low modulus allows easier relaxation of internal stress because the Young's Modulus is low. As the surface area of boron carbide of the first phase particles 103A-N increases, the amount of surface oxygen also increases. B₂O₃ melts at 450° C. and easily reacts with water vapor. Gas-cooled reactors minimize reaction with water vapor since only He gas is used as the coolant. It is still desirable to limit the amount of boron oxide, or boric acid, associated with the powder. One way to limit the amount of boron oxide, or boric acid, associated with the powder is to control the surface area (i.e., the particle size) of the boron carbide first phase particles 103A-N. Boron carbide with a starting particle size above 5 μm is typically used to make neutron absorbers. There are various approaches used to remove the surface oxide including washing with an alcohol or hot water (U.S. Pat. No. 7,919,040) or reacting with a source of carbon (U.S. Pat. Nos. 4,195,066 and 4,524,138). These approaches improve the sinterability of both boron carbide and silicon carbide-boron carbide composites.

The rate at which materials undergoing sintering coalesce can be described with a sigmodal curve, such that shrinkage is most easily controlled at the start of sintering (necking) and at the end of densification. In order to control the volume of the absorber, it is important to control the amount of shrinkage. Having a wide temperature range over which shrinkage is relatively constant is an advantage since temperature gradients exist in commercial furnaces.

A wide range of borides can be used for the example first phase 103, with boron carbide most preferred. Within the solid solutions which make up boron carbide, any ratio of boron/carbide can be used. It is preferred, however, to have a boron/carbon atomic ratio of about 4. ASTM 750 gives specifications for the starting boron carbide powder in Table 1 (see Type II powder, which is used for making SiC—B₄C composites).

A wide range of SiC powders can also be used for the example second phase 104, but it is preferable to use a powder with a surface area of at least 5 m²/g, preferably at least 10 m²/g, and most preferably about 15 m²/g. The high surface area gives fine second phase particles 104A-N that form a relatively high number of particle-particle contacts. Either alpha or beta SiC can be used, with any polytype (3C, 2H, 4H, 6H, 15R, etc.). Alpha SiC is less expensive and is therefore preferred.

While washing of the boron carbide powder for the example first phase 103 can be used to remove surface oxygen, washing is not necessary. Neither is it necessary to add a phenolic resin or another carbonaceous additive, although adding additives can occur if doing so is preferred. The advantage of not making the powders highly sinterable is that it opens the temperature range over which parts can be fired in order to neck particles together, including first phase particles 103A-N and second phase particles 104A-N. If more sinterable powders are used, then the temperature to limit the sintering process can be more precisely controlled.

Powders can be dry milled, wet milled, attrition milled, vibratory milled, jet milled, high-shear mixed, or any acceptable way to get the desired particle size of the first phase particles 103A-N and second phase particles 104A-N and make a homogeneous mixture of the boride with the silicon carbide. Dispersants are advantageous with wet milling to distribute the two phases (first phase 103 and second phase 104) evenly.

An organic binder is added to allow the powders of the first phase particles 103A-N and the second phase particles 104A-N to be molded by dry pressing, injection molding, gel casting, slip casting, or any other method. Flowable powders for dry pressing can be made using spray drying, freeze drying, pan pelletization of other techniques commonly used for making ceramic powders. Water-based processing is most economical. Dry pressing is preferably done in a uniaxial press, although wet or dry bag isostatic pressing can also be used. It is desirable to pack the powders of the first phase 103 and the second phase 104 closely together in the unfired state by using pressing pressures preferably in the range of 100 to 200 MPa.

It is possible to add a pore-former to the powder blend, but this is not necessary and only adds to the expense of making the powder. The following additional examples demonstrate the simplicity of this approach, as well as the advantages.

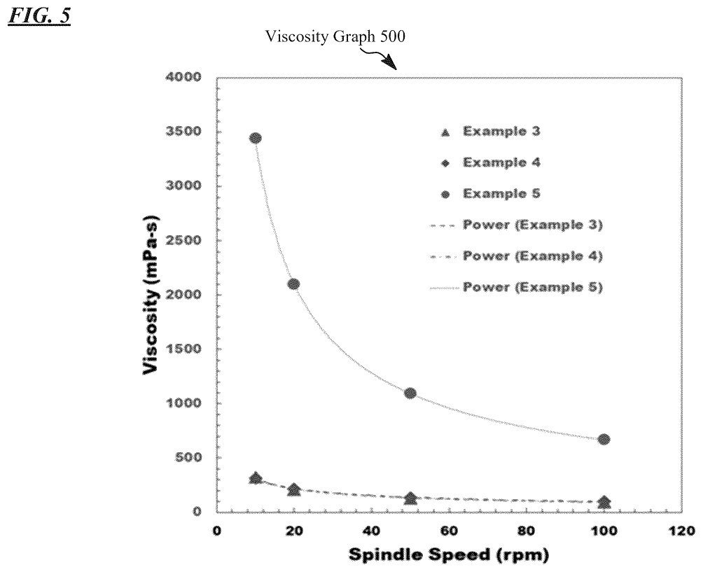

FIG. 5 is a viscosity graph 500 that shows viscosities of third, fourth, and fifth example ceramic burnable absorbers 100 (Examples 3-5). The viscosity of slurries for Examples 3-5 ceramic burnable absorbers 100 are displayed as a function of spindle speed. The viscosity graph 500 clearly indicates the increased viscosity of the slurry with the phenolic resin. All slurries had a pH in the 9-10 range. The slurries for the Examples 3-5 ceramic burnable absorbers 100 were poured into stainless steel pans, frozen, and then freeze dried to remove the water. The dried powders were screened through a 60 mesh sieve and pressed uniaxially at 138 MPa as cylinders with a mass of 10 grams, a height of 19.7 mm, and a diameter of 19.2 mm. The pressed cylinders of ceramic burnable absorbers 100 of Examples 3-5 were delubed in nitrogen (Example 3) or argon (Examples 4 and 5) at 700° C. for one hour. The ceramic burnable absorbers 100 were then fired in individual graphite crucibles by heating under vacuum to 1500° C., switching to flowing Ar, and heating at 8° C./minute to temperature (either 2000° C. or 2100° C.) and holding for one hour. The parts were cooled to 1500° C. at 8° C./minute, at which point the furnace power was shut off. Delubing in nitrogen resulted in nitrogen absorption into the parts resulting in lower weight loss and less densification (see Table 2). As shown by the data in the viscosity graph 500, there was very little shrinkage, even with the addition of the phenolic resin.

For Examples 3-5 ceramic burnable absorbers 100, the starting powders were submicron α-SiC (Washington Mills grade FPG-15) for second phase particles 104A-N and Type II B₄C for first phase particles 103A-N from U.K. Abrasives (d₅₀=11.2 μm). A phenolic resin dispersed in water, obtained from Capital Resin Corporation (grade CRC-720), was used in Example 5, with ingredients for all three examples shown in Table 1. Distilled water was the carrier, ammonium hydroxide the dispersant, and polyethylene glycol was used as a binder. Three slurries were prepared using 2 kg of either 15 mm spherical Y-TZP media (Example 3) or 12.7 mm diameter by 12.7 mm long cylindrical Y-TZP media (Examples 4 and 5) in one-liter HDPE wide-mouth jars. Distilled water was added first, followed by ammonium hydroxide, the second phase 104 (e.g., SiC), the first phase 103 (e.g., B₄C), and phenolic resin (CRC 720 has an active carbon content of approximately 50%). The slurries were rolled for ˜20 hours before adding the binder (polyethylene glycol with M.W.=8,000 g/mol) and milling an additional four hours.

TABLE 1
SiC—B₄C Compositions (mass in grams)

| Example | SiC | B₄C | CRC-720 | H₂O | NH₄OH | PEG 8000 |
|---|---|---|---|---|---|---|
| 3 | 450.96 | 49.05 | 0.0 | 300.0 | 5.5 | 15.0 |
| 4 | 520.41 | 56.60 | 0.0 | 300.0 | 5.0 | 17.3 |
| 5 | 520.41 | 56.60 | 5.9 | 300.0 | 5.0 | 17.3 |

TABLE 2
Mass Loss, Dimensional Change, and Geometrical Density for Examples 3-5

| | | | Diameter | | | |
|---|---|---|---|---|---|---|
| | Temp | % Mass | Change | % Length | Density | |
| Example | (° C.) | Change | (%) | Change | (g/cc) | % T.D. |
| 3 | 700 | −1.63 ± 0.10 | 0.03 ± 0.07 | −0.41 ± 0.47 | 1.70 ± 0.05 | 54.4 ± 1.5 |
| 3 | 2000 | −3.79 ± 0.07 | −0.64 ± 0.08 | −0.13 ± 0.87 | 1.68 ± 0.03 | 53.8 ± 1.1 |
| 4 | 700 | −2.93 ± 0.09 | 0.23 ± 0.14 | 0.71 ± 0.59 | 1.69 ± 0.01 | 53.9 ± 0.2 |
| 4 | 2000 | −4.96 ± 0.08 | −0.77 ± 0.18 | −0.47 ± 0.21 | 1.70 ± 0.01 | 54.5 ± 0.1 |
| 4 | 2100 | −4.85 ± 0.03 | −1.01 ± 0.27 | −1.62 ± 0.96 | 1.72 ± 0.01 | 55.0 ± 0.1 |
| 5 | 700 | −2.91 ± 0.03 | 0.25 ± 0.13 | −0.17 ± 0.56 | 1.68 ± 0.01 | 53.6 ± 0.2 |
| 5 | 2000 | −4.80 ± 0.03 | −0.74 ± 0.17 | −1.47 ± 0.49 | 1.70 ± 0.01 | 54.3 ± 0.2 |
| 5 | 2100 | −4.85 ± 0.06 | −1.48 ± 0.30 | −1.80 ± 0.59 | 1.73 ± 0.01 | 55.3 ± 0.3 |

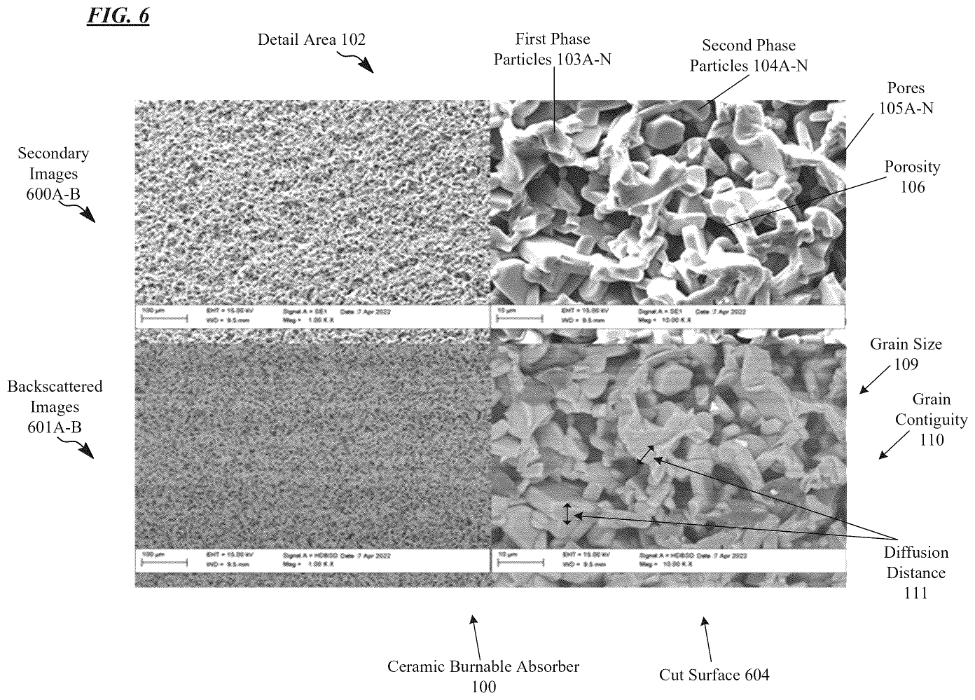

FIG. 6 show SEM images of a cut surface 604 of the fourth example ceramic burnable absorber 100 (Example 4) somewhat like that depicted in the detail area 102 of FIGS. 1A-B. The cut surface 604 is a cut cross-section of the ceramic burnable absorber 100 cut with a diamond saw before cleaning and drying. Secondary images 600A-B are shown on top and the corresponding backscattered images 601-A-B are depicted below of the cut surface 604 of Example 4, necked by heating to 2000° C. for one hour in flowing argon (Ar). FIG. 6 confirms the excellent necking between the first phase particles 103A-N and the second phase particles 104A-N of the ceramic burnable absorber 100, as seen in the cut surface 604.

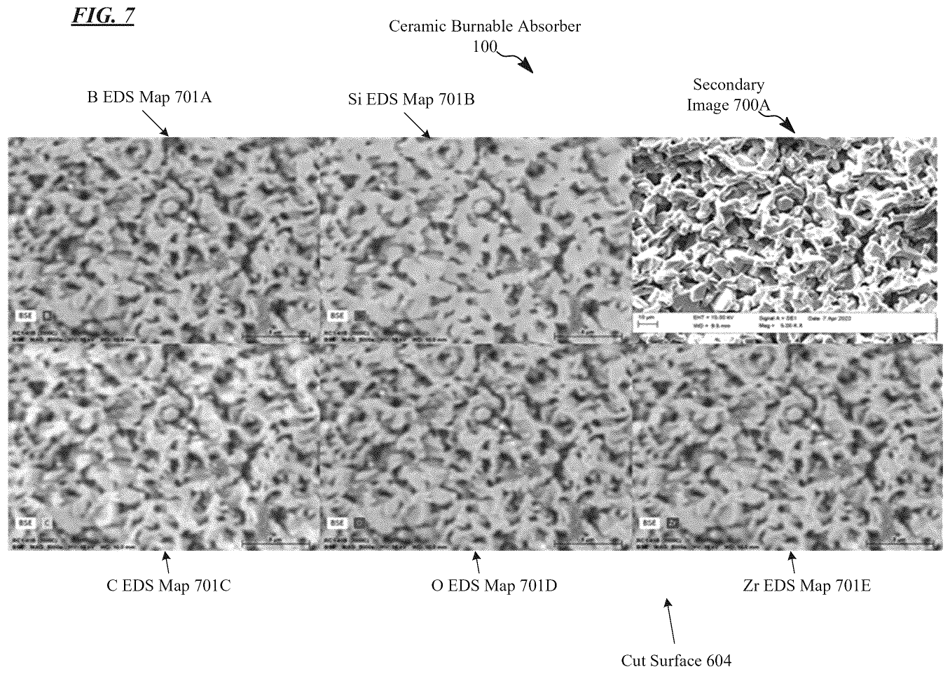

FIG. 7 uses energy dispersive spectroscopy (EDS) to map a portion of the cut surface 604 of the fourth example ceramic burnable absorber 100 of FIG. 6 (Example 4) heated to 2000° C. for one hour in flowing Ar. EDS maps 701A-E of B (green, upper left) 701A, Si (red, upper middle) 701B, C (yellow, lower left) 701C, O (blue, lower middle) 701D, and Zr (purple, lower right) 701E indicate concentrations of these elements superimposed on the image of the sample. A secondary image 700A of the area scanned is shown in the upper right corner. The EDS maps 700A-E of FIG. 7 indicate that the boron carbide of the example first phase particles 103A-N are well distributed in the SiC matrix formed by the example second phase particles 104A-N. After imaging, the Example 4 and Example 5 parts of the ceramic burnable absorber 100 were immersed in distilled water under vacuum and allowed to soak for 72 hours.

Table 3 below gives the data from these measurements, showing that the fine porosity 106 makes water infiltration into the samples of the ceramic burnable absorber 100 a very slow process. The samples of the fourth and fifth example ceramic burnable absorbers 100 were then ground with a 325 grit diamond wheel so that both ends were flat and parallel. Compressive strength was measured by using a 125 μm thick conformal graphite foil on each end and loading in between steel platens at a rate of 0.5 mm/min. The compressive strength for Examples 4 and 5 exceeded 170 MPa for all 23 samples (22 of the 23 samples did not fail and the test was stopped because the load exceeded the 50 kN load cell).

TABLE 3
Archimedes Measurements for Examples 4-5

| | Temp | Density | % Open | % Theoretical |
|---|---|---|---|---|
| Example | (° C.) | (g/cc) | Porosity | Density |
| 4 | 2000 | 1.72 ± 0.01 | 40.2 ± 3.3 | 55.2 ± 0.3 |
| 4 | 2100 | 1.75 ± 0.01 | 41.3 ± 0.8 | 56.1 ± 0.3 |
| 5 | 2000 | 1.73 ± 0.01 | 36.7 ± 1.0 | 55.2 ± 0.1 |
| 5 | 2100 | 1.77 ± 0.01 | 38.2 ± 2.9 | 56.5 ± 0.3 |

Examples 6 and 7 of the ceramic burnable absorber 100 compare two different types of commercially available B₄C for the first phase 103. Example 6 used the same boron carbide as described in Examples 3-5 and Example 7 used 1200 grit B₄C (Washington Mills lot WM 22032ZXD47) with a d₅₀ of 3.4 μm for the first phase 103. Each slip was batched in a two-liter wide-mouth, HDPE jar containing 4 kg of 15 mm cylindrical Y-TZP media. Distilled water (600 grams) was added first, followed by 10 g of NH₄OH, 1,038.5 g FCP-15 SiC for the second phase 104, and then 161.47 g B₄C for the first phase 103. The slurries had a pH in the range of 9-10. Example 6 was milled for 22 hours before adding 60 g PEG 20M (M. W.≈20,000 g/mol) and mixing for an additional 2 hours. Example 7 was milled for 2 hours, adding 60 g PEG 20M and mixing one additional hour. Both slips were freeze dried, pressed, debinderized in Ar, and then sintered in Ar as in Examples 3-5. The shrinkage was less than 2% for both compositions of the ceramic burnable absorber 100 and the porosity 106 (see Table 4) was high for both compositions of the ceramic burnable absorber 100 while maintaining well-necked structures.

TABLE 4
Archimedes Measurements for Examples 6-7

| | Temp | Density | % Open | % Theoretical |
|---|---|---|---|---|
| Example | (° C.) | (g/cc) | Porosity | Density |
| 6 | 2000 | 1.57 ± 0.01 | 49.4 ± 0.4 | 50.6 ± 0.2 |
| 6 | 2100 | 1.58 ± 0.01 | 46.5 ± 1.5 | 50.9 ± 0.2 |
| 7 | 2000 | 1.60 ± 0.01 | 48.0 ± 0.4 | 51.5 ± 0.2 |
| 7 | 2100 | 1.60 ± 0.01 | 47.2 ± 0.6 | 51.8 ± 0.3 |

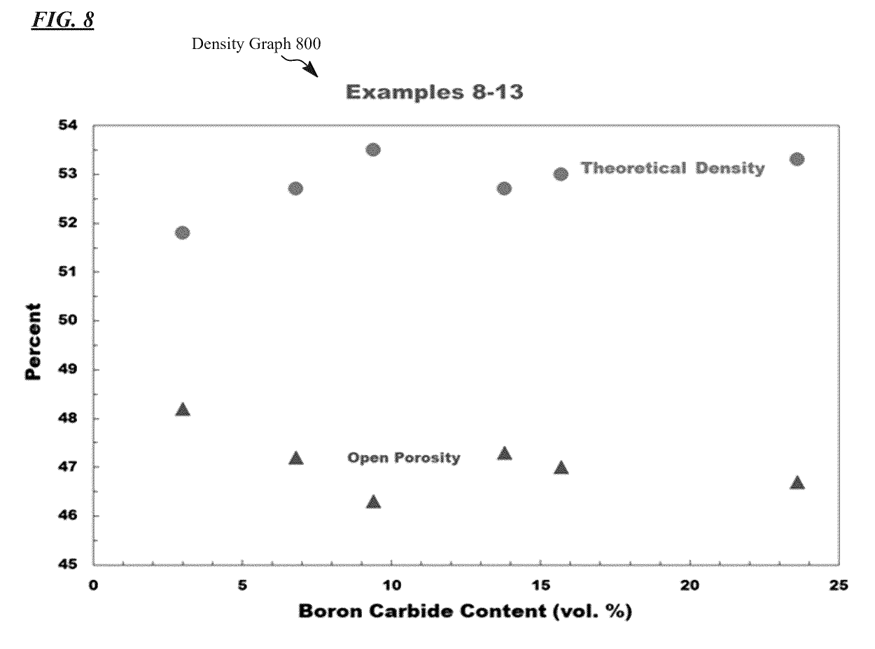

FIG. 8 is a density graph 800 that gives % theoretical density and % open porosity for of examples eighth, nine, ten, eleven, twelve, and thirteen of the ceramic burnable absorber 100 (Examples 8-13). Examples 8-13 of the ceramic burnable absorber 100 are fired at 2100° C./1 hr. In order to show that high porosity 106 can be maintained over a range of compositions, Example 8 compositions for the ceramic burnable absorber 100, as shown in Table 5, were batched using the same raw materials as Example 7 with identical processing, with samples heated to 2100° C. for one hour. As shown in density graph 800 of FIG. 8, it is possible to maintain high amounts of open porosity 106 across a range of compositions due to the well-necked microstructure. The compressive strength of the ceramic burnable absorber 100 was measured on as-fired samples (no grinding) and strengths were in excess of 150 MPa for all six compositions of Examples 8-13 ceramic burnable absorbers 100.

TABLE 5
SiC-B₄C Compositions (mass in grams)

| Example | SiC | B₄C | H₂O | NH₄OH | PEG 20M |
|---|---|---|---|---|---|
| 8 | 1,003.9 | 240.9 | 600.0 | 10.0 | 60.0 |
| 9 | 1,107.9 | 160.0 | 600.0 | 10.0 | 60.0 |
| 10 | 1,132.7 | 140.7 | 600.0 | 10.0 | 60.0 |
| 11 | 1,189.7 | 96.3 | 600.0 | 10.0 | 60.0 |
| 12 | 1,224.4 | 69.4 | 600.0 | 10.0 | 60.0 |
| 13 | 1,273.9 | 30.8 | 600.0 | 10.0 | 60.0 |

While these examples of the ceramic burnable absorber 100 show the utility of the approach using SiC—B₄C composites for the ceramic burnable absorber 100, there are a wide variety of borides (see R. A. Cutler, “Engineering Properties of Borides,” pp. 787-803 in Engineered Materials Handbook, Vol. 4 (ASM International, Materials Park, OH. 1991)) which can be used as the absorbing species of the first phase 103, as well as a corresponding array of carbide, nitrides, oxides, silicide, or solid solutions and/or mixtures of inorganic materials that can be chosen as the matrix of the second phase 104. One example important teaching is that a highly porous, well-necked, structure with a short diffusion distance 111 for He to escape to free surfaces is advantageous for ceramic burnable absorbers 100, whether they be porous Al₂O₃—B₄C, Al₂O₃—TiB₂, SiO₂—B₂O₃, Si₃N₄—BN, SiC—TiB₂, etc. SiC—B₄C composites for the ceramic burnable absorber 100 can be particularly attractive for the reasons mentioned above.

Tritium (T) is formed by the nuclear reactions ¹⁰B(n,2α)T, ¹¹B(n,⁹Be)T, and ¹⁰B(n,α)⁷Li(n,n′α)T. For ceramic burnable absorbers 100 absorbing thermal neutrons, the amount of T generation is about six orders of magnitude lower than He formation. Tritium isotopes, like deuterium isotopes and atomic hydrogen, have some solubility in boron carbide (Y. Shirasu et al., “Hydrogen Solubility in Boron Carbide,” J. Alloy Comp. 190 87-90 (1992) and V. K. Alimov et al., “Deuterium Retention in Sintered Boron Carbide Exposed to a Deuterium Plasma,” J. Nucl. Mater. 349[3] 282-290 (2006) due to icosahedral packing allowing interstitial sites for hydrogen and its isotopes).

Despite high diffusion rates, most of the tritium in the boron carbide for the example first phase 103 is trapped at defects or Li atoms. When He build up creates cracking along grain boundaries of particles 103A-N, 104A-N, T can escape into the nuclear reactor. A porous, open structure for the ceramic burnable absorber 100, as taught herein, allows more free surfaces and a greater likelihood for T evolution. To avoid any T evolution, the ceramic burnable absorbers 100 can be coated with a ceramic CVD layer 108, such as an SiC CVD layer or ZrC CVD layer, on their outer surface 107 (see FIG. 1A), since T diffusion through CVD SiC (R. A. Causey, et al., “Tritium Migration in Vapor-Deposited B—SiC,” J. Nucl. Mater. 203 196-205 (1993)) is at least three orders of magnitude slower than in boron carbide of the example first phase 103. In dense ceramic burnable absorbers 100, He builds up resulting in intergranular and/or intragranular bubble formation that may lead to cracking. It must be emphasized, however, that using dense burnable poison pellets, as commonly practiced, does not eliminate tritium migration due to microcracking caused by the evolved He. Of course, released T can be gettered (using a reactive metal (e.g. Ti) in the cold leg of the coolant loop) at lower temperatures in the nuclear reactor where hydrides are stable and have fast formation kinetics, trapping and avoiding any T release into the environment.

Control rods or plates can also comprise the ceramic burnable absorber 100 and thereby be made porous to allow for easier He release. Control rods can have much higher B-10 content than a burnable absorber pellet 101. For applications which do not require high boron concentration in the control rods this approach works well, as shown by Examples 14 and 15.

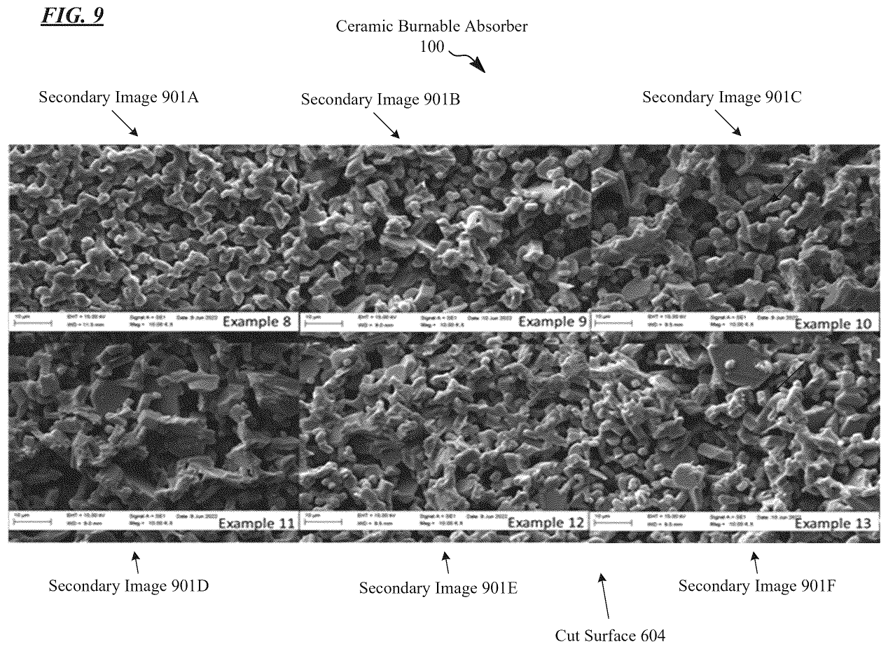

FIG. 9 displays SEM images of the cut surface 604 of Examples 8-13 of the ceramic burnable absorber 100 fired at 2100° C. for 1 hour. In particular, secondary images 901A-F are shown for the ceramic burnable absorbers 100 of Examples 8-13. Secondary image 901A is of Example 8, secondary image 901B is of Example 9, secondary image 901C is of Example 10, secondary image 901D is of Example 11, secondary image 901E is of Example 12, and secondary image 901F is of Example 13.

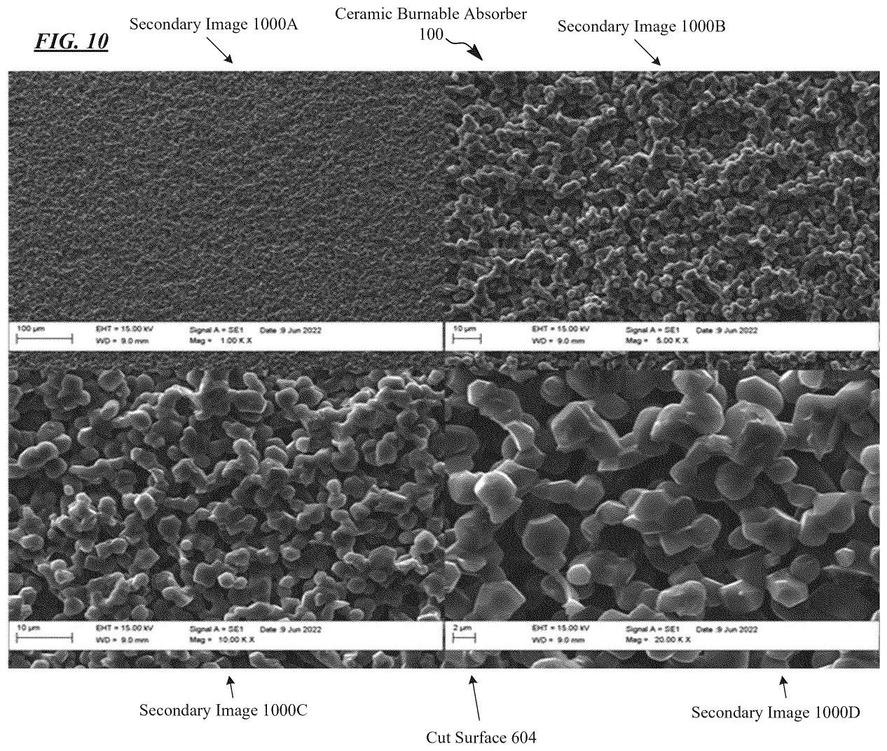

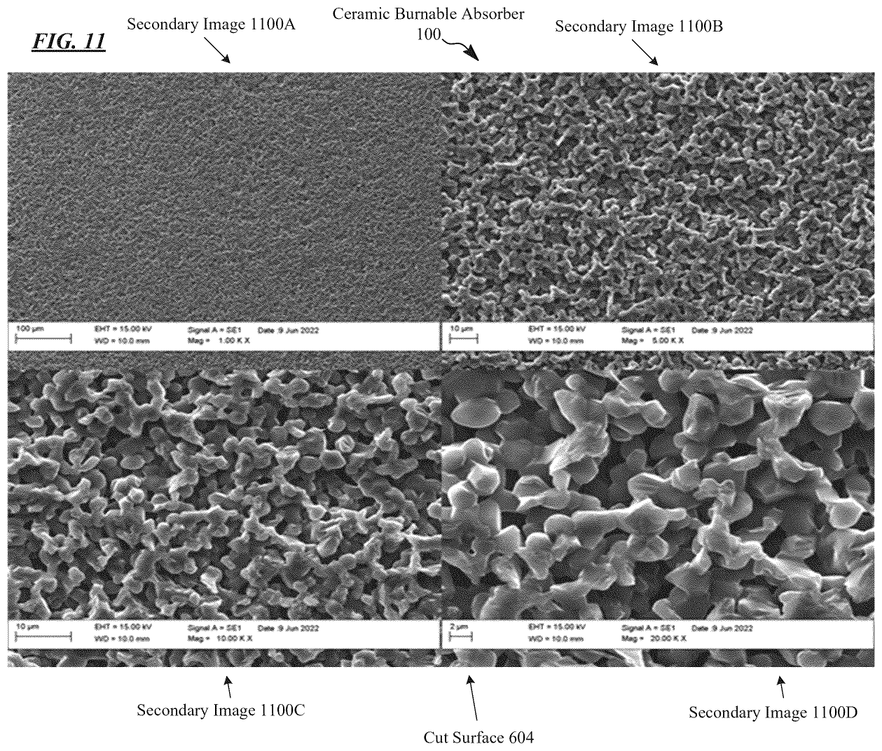

FIG. 10 shows secondary images 1000A-D of the fourteenth example of the ceramic burnable absorber 100 (Example 14), such as for forming a control rod of a nuclear reactor. FIG. 11 shows secondary images 1100A-D of the fifteenth example of the ceramic burnable absorber 100 (Example 15), such as for forming a control rod of a nuclear reactor. As noted above, Examples 14 and 15 of the ceramic burnable absorber 100 are fired at 2100° C. for 1 hour. A control rod of a nuclear reactor can include the ceramic burnable absorber 100 of Example 14 and Example 15 to regulate a neutron population in a nuclear reactor core. In some implementations, such as where porosity 106 can be incorporated into a control rod, it is not necessary to have a secondary phase 104 as the first phase 103 (e.g., boron carbide) of first phase particles 103A-N can be necked together to allow interconnected porosity 106 that is allowed to escape. In the event that tritium is not gettered downstream, the ceramic burnable absorber pellet 101 or control rod can be encased in an outer layer formed of the ceramic CVD layer 108 to allow He and T to be compressed in the pore space of the porosity 106.

For Examples 14 and 15 of the ceramic burnable absorber 100, smaller (500 ml) HDPE jars containing 1 kg of 10 mm diameter Y-TZP media and 100 grams of deionized water used NH₄OH to adjust the pH to 9-10 for slurries containing 136 g of 1200 grit B₄C for the first phase 103 (same as used in Examples 7-13). Example 14 contained no phenolic resin, while 5.44 grams of CRC 720 was added to the Example 15 slurry. Both were mixed for one hour and then processed like Examples 7-13. After firing at 2100° C. for one hour, the % theoretical density was 55.6±0.1% and 60.6±1.0% for Examples 14 and 15, respectively. Open porosity 106 was measured as 40.8±0.4% and 38.0±1.4% for Examples 14 and 15, respectively. Secondary SEM images 1000A-D, 1100A-D at four different magnifications are shown in FIG. 10 and FIG. 11 for Examples 14 and 15, respectively. The addition of well-distributed carbon aided in densification, as expected, and led to increased strength (Example 14 had strength in excess of 150 MPa and Example 15 in excess of 200 MPa). The high porosity 106 and small diffusion distances 111 due to the small boron carbide grain size 109 of first phase 103 allows for easier He escape at free surfaces as in the ceramic burnable absorbers 100. The same approaches for dealing with tritium are applicable for the control rods.

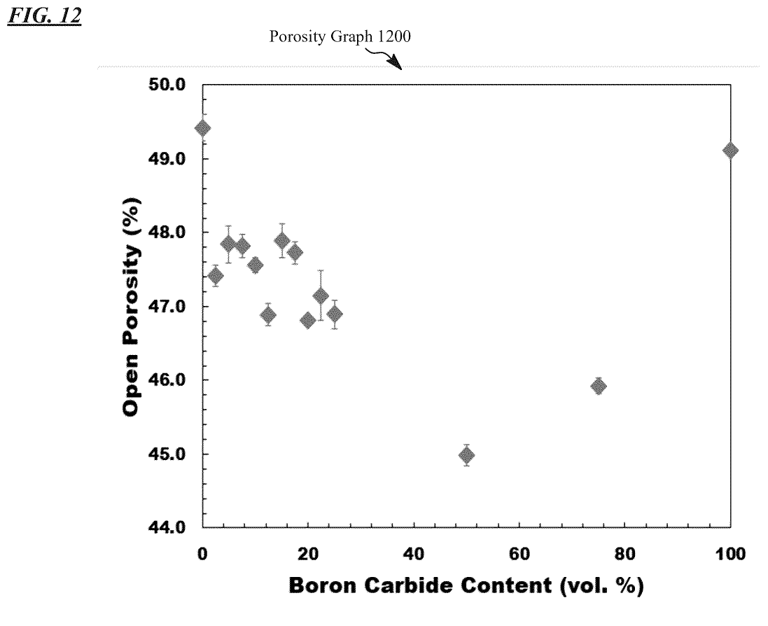

FIG. 12 is a porosity graph 1200 showing that the ceramic burnable absorber 100 can be formed with high porosity 106 over the whole spectrum of porous silicon carbide-boron carbide composites.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” “has,” “having,” “containing,” “contain”, “contains,” “with,” “formed of,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

1. A ceramic burnable absorber, comprising:
a first phase that includes a boride, a carbide, an oxide, a nitride, a silicide, a mixture, or a solid solution containing naturally occurring boron or enriched boron;
at least one second phase which bonds to the first phase;
a porosity that is interconnected and open to an outer surface of the ceramic burnable absorber and is at least 30 volume percent (vol. %) of the ceramic burnable absorber;
a grain size and a grain contiguity that limit a diffusion distance for helium to less than 10 μm; and
a compressive strength exceeding 30 MPa at approximately 0 to 100 degrees Celsius.

2. The ceramic burnable absorber of claim 1, wherein the first phase includes boron carbide and the second phase includes silicon carbide.

3. The ceramic burnable absorber of claim 1, wherein the porosity is greater than 35 vol. %.

4. The ceramic burnable absorber of claim 1, wherein the porosity is greater than 40 vol. %.

5. The ceramic burnable absorber of claim 1, wherein the porosity is greater than 45 vol. %.

6. The ceramic burnable absorber of claim 1, wherein the diffusion distance for helium is less than 5 μm.

7. The ceramic burnable absorber of claim 1, wherein the diffusion distance for helium is less than 3 μm.

8. The ceramic burnable absorber of claim 1, wherein the compressive strength exceeds 50 MPa at a room-temperature of approximately 15 to 25 degrees Celsius.

9. The ceramic burnable absorber of claim 1, wherein the compressive strength exceeds 100 MPa.

10. The ceramic burnable absorber of claim 1, wherein the ceramic burnable absorber is shaped as a pellet, a cylinder, a polyhedron, a prism, a spheroid, a tube, a pipe, a ring, a truncated portion thereof, or a combination thereof.

11. A ceramic burnable absorber, comprising
a first phase that includes a boride, a carbide, an oxide, a nitride, a silicide, a mixture, or a solid solution containing naturally occurring boron or enriched boron;
at least one second phase which bonds to the first phase;
a porosity that is interconnected and is at least 30 volume percent (vol. %) of the ceramic burnable absorber;
a grain size and a grain contiguity that limit a diffusion distance for helium to less than 10 μm;
a compressive strength exceeding 30 MPa at approximately 0 to 100 degrees Celsius; and
a ceramic chemical vapor deposition (CVD) layer greater than 20 μm in thickness.

12. A ceramic burnable absorber, comprising:
at least 95 wt. % boron carbide with a porosity in excess of 30 volume percent (vol. %);
a grain size and a grain contiguity that limit a diffusion distance for helium to less than 10 μm; and
a compressive strength exceeding 30 MPa at approximately 0 to 100 degrees Celsius.

13. The ceramic burnable absorber of claim 12, wherein the first phase includes boron carbide and the second phase includes silicon carbide.

14. The ceramic burnable absorber of claim 12, wherein the porosity is greater than 35 vol. %.

15. The ceramic burnable absorber of claim 12, wherein the porosity is greater than 40 vol. %.

16. The ceramic burnable absorber of claim 12, wherein the porosity is greater than 45 vol. %.

17. The ceramic burnable absorber of claim 12, wherein the diffusion distance for helium is less than 5 μm.

18. The ceramic burnable absorber of claim 12, wherein the diffusion distance for helium is less than 3 μm.

19. The ceramic burnable absorber of claim 12, wherein the compressive strength exceeds 50 MPa at a room-temperature of approximately 15 to 25 degrees Celsius.

20. The ceramic burnable absorber of claim 12, wherein the compressive strength exceeds 100 MPa.

21. (canceled)

22. (canceled)

23. (canceled)

24. (canceled)
